(19) United States
(12) Patent Application Publication
(10) Pub. No.: US 2016/0170508 A1
(43) Pub. Date: Jun. 16, 2016

(54) TACTILE DISPLAY DEVICES

(71) Applicant: Toyota Motor Engineering & Manufacturing North America, Inc., Erlanger, KY (US)

(72) Inventors: Douglas A. Moore, Livermore, CA (US); Joseph M.A. Djugash, San Jose, CA (US); Yasuhiro Ota, Santa Clara, CA (US); Shin Sano, San Francisco, CA (US); Sarah Rosenbach, Berkeley, CA (US); Sho Hiruta, San Francisco, CA (US); Maura Hoven, San Francisco, CA (US)

(73) Assignee: Toyota Motor Engineering & Manufacturing North America, Inc., Erlanger, KY (US)

(21) Appl. No.: 14/567,046

(22) Filed: Dec. 11, 2014

(51) Int. Cl. G06F 3/041

(52) U.S. Cl. CPC G06F 3/041

(57) ABSTRACT

Embodiments of tactile display devices are disclosed. In one embodiment, a tactile display device includes a housing having a first surface, a tactile display located at the first surface, a camera, a processor, and a non-transitory memory device. The tactile display is configured to produce a plurality of raised portions defining a tactile message. The camera generates image data corresponding to an environment. The processor is disposed within the housing and communicatively coupled to the tactile display and the camera. The non-transitory memory device stores machine-readable instructions that, when executed by the processor, cause the processor to, generate a topographical map of objects within the environment from the image data received from the camera, generate tactile display data corresponding to the topographical map, and provide the tactile display data to the tactile display such that the tactile display produces the plurality of raised portions to form the tactile message.

### TECHNICAL FIELD

The present specification generally relates to tactile display devices and, more particularly, to tactile display devices capable of displaying tactile topographical information to blind or visually impaired users.

### BACKGROUND

Blind or visually impaired persons may find it difficult to navigate within their environment. Aid devices such as a cane may provide a visually impaired person with haptic feedback regarding objects that are within his or her vicinity. A guide dog may be used to assist in guiding a blind or visually impaired person through the environment. However, it may be very difficult for a blind or visually impaired person to have an understanding of objects within the environment, such as the location of people, obstacles, and signs.

Accordingly, a need exists for devices that provide blind or visually impaired people with environmental information in a manner that is not reliant on human vision.

### SUMMARY

In one embodiment, a tactile display device includes a housing having a first surface, a tactile display located at the first surface, a camera, a processor, and a non-transitory memory device. The tactile display is configured to produce a plurality of raised portions defining a tactile message. The camera is configured to generate image data corresponding to an environment. The processor is disposed within the housing and communicatively coupled to the tactile display and the camera. The non-transitory memory device stores machine-readable instructions that, when executed by the processor, cause the processor to generate a topographical map of objects within the environment from the image data received from the camera, generate tactile display data corresponding to the topographical map, and provide the tactile display data to the tactile display such that the tactile display produces the plurality of raised portions to form the tactile message.

In another embodiment, a tactile display device includes a housing having a first surface and a second surface that is opposite from the first surface, a tactile display located at the first surface of the housing, a touch-sensitive input region disposed on a surface of the tactile display, an input device disposed at the second surface of the housing, a camera, a processor, and a non-transitory memory device. The tactile display is configured to produce a plurality of raised portions defining a tactile message. The camera is configured to generate image data corresponding to an environment. The non-transitory memory device stores machine-readable instructions that, when executed by the processor, cause the processor to receive a user input from the input device or the touch-sensitive input region, analyze the image data to determine a class of objects within the environment, wherein the user input indicates a desired class of objects for display in the tactile message, generate a topographical map of objects having the desired class according to the user input, generate tactile display data corresponding to the topographical map, and provide the tactile display data to the tactile display such that the tactile display produces the plurality of raised portions to form the tactile message.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically illustrates components of an example tactile display device according to one or more embodiments described and illustrated herein;

FIG. 2 schematically illustrates a front surface of an example tactile display device according to one or more embodiments described and illustrated herein;

FIG. 3 schematically illustrates a rear surface of the example tactile display device illustrated in FIG. 2 according to one or more embodiments described and illustrated herein; and

FIGS. 4 and 5 illustrate a user using a tactile display device according to one or more embodiments described and illustrated herein.

### DETAILED DESCRIPTION

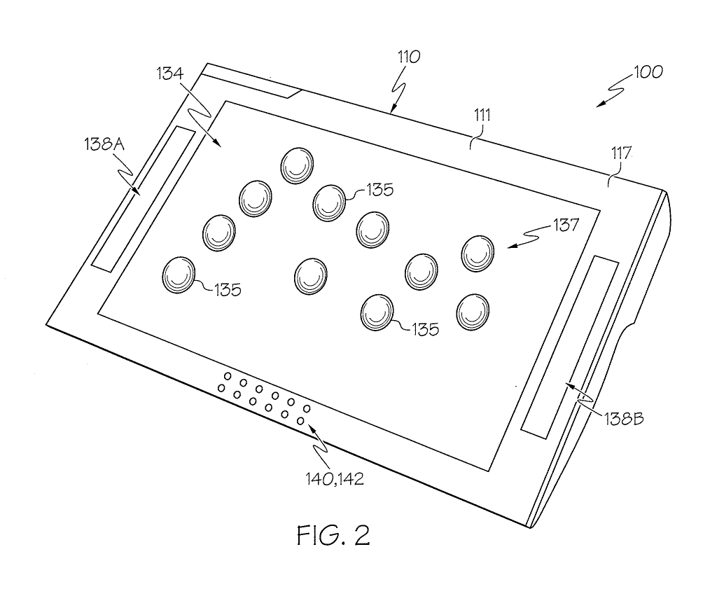

Referring generally to FIG. 2, embodiments of the present disclosure are directed to tactile display devices for blind or visually impaired users. Embodiments are configured to capture information regarding a user's environment and generate tactile messages in a tablet-shaped form factor. More specifically, embodiments of the present disclosure capture image data of a user's environment that is converted into a topographical map that is displayed on a tactile display in the form of one or more tactile messages. A user may select the type of objects that he or she would like to be displayed on the tactile display. The tactile message may indicate to the user the presence and location of objects within the user's environment. Embodiments may also convert written text to Braille, among other functionalities. Various embodiments of tactile display devices are described in detail below.

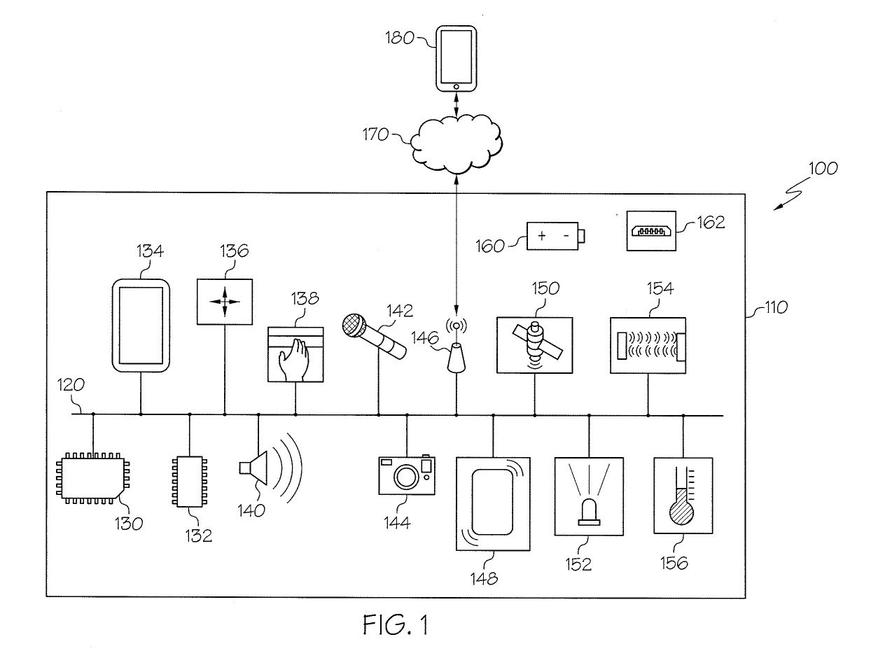

Referring now to FIG. 1, example components of one embodiment of a tactile display device 100 is schematically depicted. The tactile display device 100 includes a housing 110, a communication path 120, a processor 130, a memory module 132, a tactile display 134, an inertial measurement unit 136, an input device 138, an audio output device 140 (e.g., a speaker), a microphone 142, a camera 144, network interface hardware 146, a tactile feedback device 148, a location sensor 150, a light 152, a proximity sensor 154, a temperature sensor 156, a battery 160, and a charging port 162. The components of the tactile display device 100 other than the housing 110 may be contained within or mounted to the housing 110. The various components of the tactile display device 100 and the interaction thereof will be described in detail below.

Still referring to FIG. 1, the communication path 120 may be formed from any medium that is capable of transmitting a signal such as, for example, conductive wires, conductive traces, optical waveguides, or the like. Moreover, the communication path 120 may be formed from a combination of mediums capable of transmitting signals. In one embodiment, the communication path 120 comprises a combination of conductive traces, conductive wires, connectors, and buses that cooperate to permit the transmission of electrical data signals to components such as processors, memories, sensors, input devices, output devices, and communication devices. Accordingly, the communication path 120 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 120 communicatively couples the various components of the tactile display device 100. As used herein, the term “communicatively coupled” means that coupled components are capable of exchanging data signals with one another such as, for example, electrical signals via conductive medium, electromagnetic signals via air, optical signals via optical waveguides, and the like.

The processor 130 of the tactile display device 100 may be any device capable of executing machine-readable instructions. Accordingly, the processor 130 may be a controller, an integrated circuit, a microchip, a computer, or any other computing device. The processor 130 is communicatively coupled to the other components of the tactile display device 100 by the communication path 120. Accordingly, the communication path 120 may communicatively couple any number of processors with one another, and allow the components coupled to the communication path 120 to operate in a distributed computing environment. Specifically, each of the components may operate as a node that may send and/or receive data. While the embodiment depicted in FIG. 1 includes a single processor 130, other embodiments may include more than one processor.

Still referring to FIG. 1, the memory module 132 of the tactile display device 100 is coupled to the communication path 120 and communicatively coupled to the processor 130. The memory module 132 may comprise RAM, ROM, flash memories, hard drives, or any non-transitory memory device capable of storing machine readable instructions such that the machine readable instructions can be accessed and executed by the processor 130. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored in the memory module 132. Alternatively, the machine readable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 1 includes a single memory module 132, other embodiments may include more than one memory module.

The tactile display 134 is coupled to the communication path 120 and communicatively coupled to the processor 130. The tactile display 134 may be any device capable of providing tactile output in the form of refreshable tactile messages. A tactile message conveys information to a user by touch. For example, a tactile message may be in the form of a tactile writing system, such as Braille. A tactile message may also be in the form of any shape, such as the shape of an object detected in the environment. A tactile message may be a topographic map of an environment.

Any known or yet-to-be-developed tactile display may be used. In some embodiments, the tactile display 134 is a three dimensional tactile display including a surface, portions of which may raise to communicate information. The raised portions may be actuated mechanically in some embodiments (e.g., mechanically raised and lowered pins). The tactile display 134 may also be fluidly actuated, or it may be configured as an electrovibration tactile display. The tactile display 134 is configured to receive tactile display data, and produce a tactile message accordingly. It is noted that the tactile display 134 can include at least one processor and/or memory module.

The inertial measurement unit 136 is coupled to the communication path 120 and communicatively coupled to the processor 130. The inertial measurement unit 136 may include one or more accelerometers and one or more gyroscopes. The inertial measurement unit 136 transforms sensed physical movement of the tactile display device 100 into a signal indicative of an orientation, a rotation, a velocity, or an acceleration of the tactile display device 100. As an example and not a limitation, the tactile message displayed by the tactile display 134 may depend on an orientation of the tactile display device 100 (e.g., whether the tactile display device 100 is horizontal, tilted, and the like). Some embodiments of the tactile display device 100 may not include the inertial measurement unit 136, such as embodiments that include an accelerometer but not a gyroscope, embodiments that include a gyroscope but not an accelerometer, or embodiments that include neither an accelerometer nor a gyroscope.

Still referring to FIG. 1, one or more input devices 138 are coupled to the communication path 120 and communicatively coupled to the processor 130. The input device 138 may be any device capable of transforming user contact into a data signal that can be transmitted over the communication path 120 such as, for example, a button, a switch, a knob, a microphone or the like. In some embodiments, the input device 138 includes a power button, a volume button, an activation button, a scroll button, or the like. The one or more input devices 138 may be provided so that the user may interact with the tactile display device 100, such as to navigate menus, make selections, set preferences, and other functionality described herein. In some embodiments, the input device 138 includes a pressure sensor, a touch-sensitive region, a pressure strip, or the like. It should be understood that some embodiments may not include the input device 138. As described in more detail below, embodiments of the tactile display device 100 may include multiple input devices disposed on any surface of the housing or the tactile display 134 (e.g., one or more touch-sensitive regions disposed on the tactile display 134 and one or more input devices (e.g., switches, touch-sensitive regions, etc.) disposed on a second surface of the housing 110.

The speaker 140 (i.e., an audio output device) is coupled to the communication path 120 and communicatively coupled to the processor 130. The speaker 140 transforms audio message data from the processor 130 of the tactile display device 100 into mechanical vibrations producing sound. For example, the speaker 140 may provide to the user navigational menu information, setting information, status information, information regarding the environment as detected by image data from the one or more cameras 144, and the like. However, it should be understood that, in other embodiments, the tactile display device 100 may not include the speaker 140.

The microphone 142 is coupled to the communication path 120 and communicatively coupled to the processor 130. The microphone 142 may be any device capable of transforming a mechanical vibration associated with sound into an electrical signal indicative of the sound. The microphone 142 may be used as an input device 138 to perform tasks, such as navigate menus, input settings and parameters, and any other tasks. It should be understood that some embodiments may not include the microphone 142.

Still referring to FIG. 1, the camera 144 is coupled to the communication path 120 and communicatively coupled to the processor 130. The camera 144 may be any device having an array of sensing devices (e.g., pixels) capable of detecting radiation in an ultraviolet wavelength band, a visible light wavelength band, or an infrared wavelength band. The camera 144 may have any resolution. The camera 144 may be an omni-directional camera, or a panoramic camera. In some embodiments, one or more optical components, such as a mirror, fish-eye lens, or any other type of lens may be optically coupled to the camera 144. As described in more detail below, embodiments may utilize a first camera and a second camera to produce a stereoscopic image for providing depth information that may be represented by the tactile display 134.

The network interface hardware 146 is coupled to the communication path 120 and communicatively coupled to the processor 130. The network interface hardware 146 may be any device capable of transmitting and/or receiving data via a network 170. Accordingly, network interface hardware 146 can include a communication transceiver for sending and/or receiving any wired or wireless communication. For example, the network interface hardware 146 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, network interface hardware 146 includes hardware configured to operate in accordance with the Bluetooth wireless communication protocol. In another embodiment, network interface hardware 146 may include a Bluetooth send/receive module for sending and receiving Bluetooth communications to/from a portable electronic device 180. The network interface hardware 146 may also include a radio frequency identification (“RFID”) reader configured to interrogate and read RFID tags.

In some embodiments, the tactile display device 100 may be communicatively coupled to a portable electronic device 180 via the network 170. In some embodiments, the network 170 is a personal area network that utilizes Bluetooth technology to communicatively couple the tactile display device 100 and the portable electronic device 180. In other embodiments, the network 170 may include one or more computer networks (e.g., a personal area network, a local area network, or a wide area network), cellular networks, satellite networks and/or a global positioning system and combinations thereof. Accordingly, the tactile display device 100 can be communicatively coupled to the network 170 via wires, via a wide area network, via a local area network, via a personal area network, via a cellular network, via a satellite network, or the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

Still referring to FIG. 1, as stated above, the network 170 may be utilized to communicatively couple the tactile display device 100 with the portable electronic device 180. The portable electronic device 180 may include a mobile phone, a smartphone, a personal digital assistant, a camera, a dedicated mobile media player, a mobile personal computer, a laptop computer, and/or any other portable electronic device capable of being communicatively coupled with the tactile display device 100. The portable electronic device 180 may include one or more processors and one or more memories. The one or more processors can execute logic to communicate with the tactile display device 100. The portable electronic device 180 may be configured with wired and/or wireless communication functionality for communicating with the tactile display device 100. In some embodiments, the portable electronic device 180 may perform one or more elements of the functionality described herein, such as in embodiments in which the functionality described herein is distributed between the tactile display device 100 and the portable electronic device 180.

The tactile feedback device 148 is coupled to the communication path 120 and communicatively coupled to the processor 130. The tactile feedback device 148 may be any device capable of providing tactile feedback to a user. The tactile feedback device 148 may include a vibration device (such as in embodiments in which tactile feedback is delivered through vibration), an air blowing device (such as in embodiments in which tactile feedback is delivered through a puff of air), or a pressure generating device (such as in embodiments in which the tactile feedback is delivered through generated pressure). It should be understood that some embodiments may not include the tactile feedback device 148.

The location sensor 150 is coupled to the communication path 120 and communicatively coupled to the processor 130. The location sensor 150 may be any device capable of generating an output indicative of a location. In some embodiments, the location sensor 150 includes a global positioning system (GPS) sensor, though embodiments are not limited thereto. Some embodiments may not include the location sensor 150, such as embodiments in which the tactile display device 100 does not determine a location of the tactile display device 100 or embodiments in which the location is determined in other ways (e.g., based on information received from the camera 144, the microphone 142, the network interface hardware 146, the proximity sensor 154, the inertial measurement unit 136 or the like). The location sensor 150 may also be configured as a wireless signal detection device capable of triangulating a location of the tactile display device 100 and the user by way of wireless signals received from one or more wireless signal antennas.

Still referring to FIG. 1, the light 152 is coupled to the communication path 120 and communicatively coupled to the processor 130. The light 152 may be any device capable of outputting light, such as but not limited to a light emitting diode, an incandescent light, a fluorescent light, or the like. Some embodiments include a power indicator light that is illuminated when the tactile display device 100 is powered on. Some embodiments include an activity indicator light that is illuminated when the tactile display device 100 is active or processing data. Some embodiments include an illumination light for illuminating the environment in which the tactile display device 100 is located. Some embodiments may not include the light 152, such as embodiments in which visual output is provided via the tactile display 134, or embodiments in which no light output is provided.

The proximity sensor 154 is coupled to the communication path 120 and communicatively coupled to the processor 130. The proximity sensor 154 may be any device capable of outputting a proximity signal indicative of a proximity of the tactile display device 100 to another object. In some embodiments, the proximity sensor 154 may include a laser scanner, a capacitive displacement sensor, a Doppler effect sensor, an eddy-current sensor, an ultrasonic sensor, a magnetic sensor, an optical sensor, a radar sensor, a sonar sensor, or the like. Some embodiments may not include the proximity sensor 154, such as embodiments in which the proximity of the tactile display device 100 to an object is determine from inputs provided by other sensors (e.g., the camera 144, the speaker 140, etc.) or embodiments that do not determine a proximity of the tactile display device 100 to an object.

The temperature sensor 156 is coupled to the communication path 120 and communicatively coupled to the processor 130. The temperature sensor 156 may be any device capable of outputting a temperature signal indicative of a temperature sensed by the temperature sensor 156. In some embodiments, the temperature sensor 156 may include a thermocouple, a resistive temperature device, an infrared sensor, a bimetallic device, a change of state sensor, a thermometer, a silicon diode sensor, or the like. Some embodiments of the tactile display device 100 may not include the temperature sensor 156.

Still referring to FIG. 1, the tactile display device 100 is powered by the battery 160, which is electrically coupled to the various electrical components of the tactile display device 100. The battery 160 may be any device capable of storing electric energy for later use by the tactile display device 100. In some embodiments, the battery 160 is a rechargeable battery, such as a lithium-ion battery or a nickel-cadmium battery. In embodiments in which the battery 160 is a rechargeable battery, the tactile display device 100 may include the charging port 162, which may be used to charge the battery 160. Some embodiments may not include the battery 160, such as embodiments in which the tactile display device 100 is powered the electrical grid, by solar energy, or by energy harvested from the environment. Some embodiments may not include the charging port 162, such as embodiments in which the apparatus utilizes disposable batteries for power.

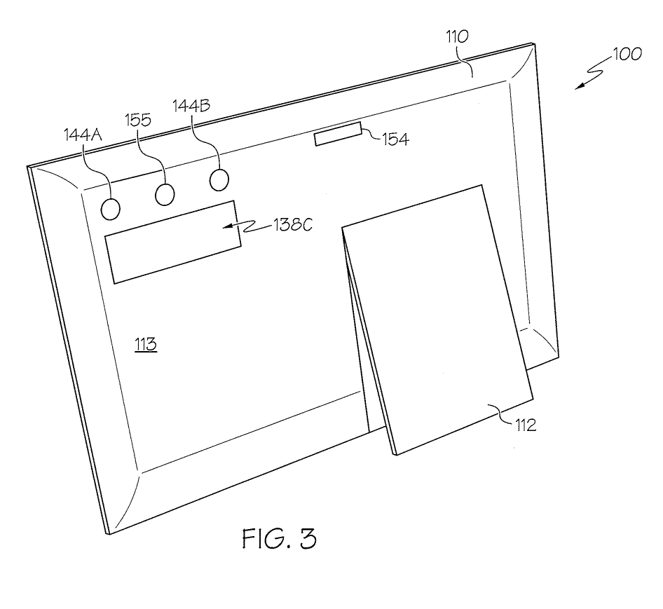

FIGS. 2 and 3 illustrate front 111 and rear surfaces 113 of an example tactile display device 100, respectively. The tactile display device 100 may be operated by a visually impaired or blind user to receive information regarding his or her environment via tactile messages provided by a tactile display 134. Environmental information may be, without limitation, a topographical map of the environment, the location of objects within the environment, people within the environment, text of signs within the environment, and text of documents.

The housing 110 of the example tactile display device 100 provides a tablet-shaped device. It should be understood that embodiments of the present disclosure are not limited to the configuration of the tactile display device 100, and that the example tactile display device of FIGS. 2 and 3 are for illustrative purposes only.

Referring to FIG. 2, the tactile display 134 is disposed within the front surface 111 of the tactile display device 100. In the illustrated embodiment, the housing 110 defines a bezel 117 surrounding the tactile display 134. As described above with reference to FIG. 1, the tactile display 134 is configured to produce raised portions 135 that provide a refreshable tactile message 137 to the user. The display device 134 may receive tactile display data from the processor 130 (see FIG. 1) and produce the raised portions 135 of the tactile message 137 accordingly. The user may feel the raised portions 135 of the tactile display 134 with his or her hand to read the tactile message 137.

Depending on the type of display device 134, the raised portions 135 may be made up of a plurality of tactile pixels (e.g., individual pins or pockets of fluid). The tactile pixels may be raised and lowered according to the tactile display data to produce the tactile message 137. As stated above, the tactile message 137 may be related to anything of interest to the user, such as a topographic map of the environment, the location of specific types of objects in the environment, a tactile representation of an object, symbols, Braille text of documents, and the like. In some embodiments, each raised portion 135 may be a representation of an object that is within the environment. As a non-limiting example, one or more of the raised portions 135 may include a Braille message that describes the particular object (e.g., the class of the object, a person's name, and the like).

The format of the tactile message 137 may be customizable depending on the preferences of the user. For example, the individual raised portions 135 may be spatially positioned within the tactile message 137 based on their location in the environment as shown in FIG. 2. Alternatively, or in addition to, Braille text may be displayed to provide information regarding objects within the environment. As a non-limiting example, the tactile message 137 may include a Braille message that reads “there is restroom to your left.”

Several components may be provided in the bezel 117, such as microphone 142, speaker 140, and input devices 138A, 138B. As described above with reference to FIG. 1, the speaker 140 may provide sound to the user. The sound may provide auditory information regarding operation of the tactile display device 100 (e.g., tips on how to operate the tactile display device 100, how to operate navigational menus, prompt the user to enter inputs, and the like). For example, the speaker 140 may receive auditory data from the processor 130 and produce sound accordingly. The microphone 142, which is also communicatively coupled to the processor 130, may be used to provide input or otherwise control the tactile display device 100. For example, the user may speak into the microphone 142 to set parameters and navigate menus of the tactile display device 100.

In the illustrated embodiment, input devices 138 are provided within the bezel 117 of the housing 110. The input devices 138A, 138B may be configured as one or more touch-sensitive regions in which the user may provide input to the tactile display device 100 as well as navigate menus, for example. The touch-sensitive regions may be formed by a touch sensitive film, in some embodiments. However, as stated above, any type of input device may be provided including, but not limited to, buttons, mechanical switches, and pressure switches. It should be understood that embodiments are not limited to the number and placement of input devices 138A, 138B shown in FIG. 2. In some embodiments, a surface of the tactile display 134 is also touch-sensitive, thereby providing additional locations for receiving user input.

Referring now to FIG. 3, a rear surface 113 of the example tactile display device 100 shown in FIG. 2 is depicted. Several components are disposed within the housing 110 at the rear surface 113. It should be understood that embodiments of the present disclosure are not limited to the configuration of components within the rear surface 113 of the tactile display device 100 illustrated in FIG. 3. An input device 138C is provided at the rear surface 113 so that the user may provide inputs to the tactile display device 100 while simultaneously holding the tactile display device 100 and feeling the tactile display 134. The input device 138C may take on any form. Additional input devices 138 may also be provided at the rear surface 113. Alternatively, no rear surface 113 input devices 138 may be provided.

In the illustrated embodiment, a camera assembly is defined by a first camera 144A and a second camera 144B. In other embodiment, only a single camera 144 may be provided. The first and second cameras 144A, 144B may each capture image data (i.e., digital images) of the environment. As described in more detail below, the image data is provided to the processor 130 to create a topographical map of the environment, which is then provided to the user as a tactile message 137 by the tactile display 134. The image data from each of the first camera 144A and the second camera 144B (i.e., a first image and a second image) may be combined to create a stereoscopic image in which depth information is extracted. The tactile message 137 may provide such depth information to the user.

In some embodiments, a light 155 (e.g., a flash or continuously on light) may be provided at the rear surface 113 to illuminate the environment when the first and second cameras 144A, 144B capture image data. (e.g., one or more light emitting diode lights). It should be understood that in some embodiments the rear surface light 155 may not be provided.

In the illustrated embodiment, the proximity sensor 154 is provided at the rear surface 113 of the tactile display device 100. As described above, the proximity sensor may provide information as to the proximity of the tactile display device 100 to an object. Such proximity information may be used to generate the topographical map that is displayed in the tactile message 137.

The illustrated tactile display device 100 comprises a kickstand 112 at the rear surface 113. The kickstand 112 may be used to keep the tactile display device 100 in an upright position when placed on a surface, such as a table or desk.

A user of the tactile display device 100 may take a picture of his or her environment with the tactile display device 100. For example, the user may control the tactile display device 100 using one or more input devices 138 (and/or microphone 142) to take a picture (i.e., capture image data) with the first and second cameras 144A, 144B (or single camera 144). The user may also input preferences using the one or more input device 138 (and/or microphone 142) regarding the class or type of objects that he or she wishes to display in the tactile display 134. For example, the user may desire to gain insight with respect to one or more particular types of objects in his or her environment. Example classes of objects include, but are not limited to, people, tables, empty seats, doorways, walls, restrooms, and water fountains. Accordingly, only those objects meeting one of the selected classes will be displayed in the tactile message 137.

The image data may be a single image from each of the first and second camera 144A, 144B or a plurality of sequential images. The image data captured by the first and second cameras 144A, 144B may be provided to the processor 130, which then analyzes the image data. One or more object recognition algorithms may be applied to the image data to extract objects having the particular class selected by the user. Any known or yet-to-be-developed object recognition algorithms may be used to extract the objects from the image data. Example object recognition algorithms include, but are not limited to, scale-invariant feature transform (“SIFT”), speeded up robust features (“SURF”), and edge-detection algorithms. Any known or yet-to-be developed facial recognition algorithms may also be applied to the image data to detect particular people within the environment. For example, the user may input the names of particular people he or she would like to detect. Data regarding the facial features of people may be stored in the memory module 132 and accessed by the facial recognition algorithms when analyzing the image data. The object recognition algorithms and facial recognition algorithms may be embodied as software stored in the memory module 132, for example.

The objects extracted from the image data may be utilized by the processor 130 to generate a topographical map of the user's environment. A topographical map is a map that provides spatial information regarding objects that are in the user's environment. For example, the topographical map may indicate the presence and position of particular objects, such as empty seats, doorways, tables, people, and the like. Referring specifically to FIG. 2, each raised portion 135 may represent a particular object. As stated above, the raised portions 135 may also be configured as individual Braille messages representing the individual objects in some embodiments. The topographical map is provided to the tactile display 134 as tactile display data. In some embodiments, the raised features 135 may take on a particular shape depending on the class of object (e.g., a circle for a chair, a star for a person, etc.).

In some embodiments, the tactile display device 100 is configured to extract text that is present in the image data. For example, the tactile display device 100 may detect the text of signs that are present within the user's environment. The processor 130, using a text-detection algorithm (e.g., optical character recognition), may detect and extract any text from the image data for inclusion in the tactile message 137. As an example and not a limitation, the image data may have captured an “EXIT” sign in the environment. The processor 130 may detect and extract the word and location of the “EXIT” sign in the environment and generate the topographical map accordingly. The tactile message 137 may then indicate the presence and location of the “EXIT” sign to the user.

As stated above, information extracted from image data may also be converted to auditory data that is sent to the speaker 140 for playback of an audio message. As non-limiting examples, the speaker 140 may produce an auditory message regarding the number of empty seats in the room, or the presence of a particular person. The auditory message may provide any type of information to the user.

In some embodiments, topographical map information may be stored in the memory module 132 or stored remotely and accessible via the network interface hardware 146 and network 170. For example, the topographical map information may be stored on a portable electronic device 180 or on a remote server maintained by a third party map data provider.

The topographical map information may be based on a location of a user, or based on another location inputted by the user. The location of the tactile display device 100 and therefore the user may be determined by any method. For example, the location sensor 150 may be used to determine the location of the user (e.g., by a GPS sensor). Wireless signals, such as cellular signals, WiFi signals, and Bluetooth® signals may be used to determine the location of the user.

The topographical map information may include data relating to external maps, such as roads, footpaths, buildings, and the like. The topographical map information may also include data relating to interior spaces of buildings (e.g., location of rooms, doorways, walls, etc.). The topographical map information may provide additional information regarding the user's environment beyond the objects extracted from the image data.

The processor 130 may access the topographical map information when generating the topographical map. The topographical map may comprise any combination of objects extracted from image data and/or the topographical map information.

In some embodiments, the tactile message 137 displayed on the tactile display 134 provides a navigational route from a first location to a second location. For example, the tactile display device 100 may be configured to generate a tactile map including obstacles and a navigational route in the form of tactile arrows or lines that indicate to the user the path to follow. The navigational route may also be provided in the tactile message as Braille text providing directions. Accordingly, the tactile display of navigation route information may take on many forms.

In some embodiments, the tactile display device 100 may be configured to translate written text into Braille or other tactile writing system. In this manner, the user of the tactile display device 100 may be able to read written text. As an example and not a limitation, a user may take a picture of a page of text using the tactile display device 100. Using optical character recognition, the tactile display device 100 (e.g., using the processor 130 and/or other hardware) may extract or otherwise determine the text from the image data. A tactile representation of the extracted text may then be provided by the tactile message 137 (e.g., Braille text).

In some embodiments, the inertial measurement unit 136 may be included in the tactile display device 100 for additional functionality. The auditory and/or tactile output of the tactile display device 100 may depend on an orientation of the tactile display device 100 as detected by the inertial measurement unit 136. As an example and not a limitation, when the tactile display device 100 is oriented in a horizontal orientation with respect to the ground, the tactile display device 100 may preemptively initiate the optical character recognition process without user input because of the high likelihood that the user is taking a picture of text when the tactile display device 100 is in this orientation. Similarly, when the user is holding the tactile display device 100 in non-horizontal position (e.g., vertical), the tactile display device 100 may preemptively capture image data and initiate the object recognition algorithm(s) because of the high likelihood that the user is taking a picture of his or her environment.

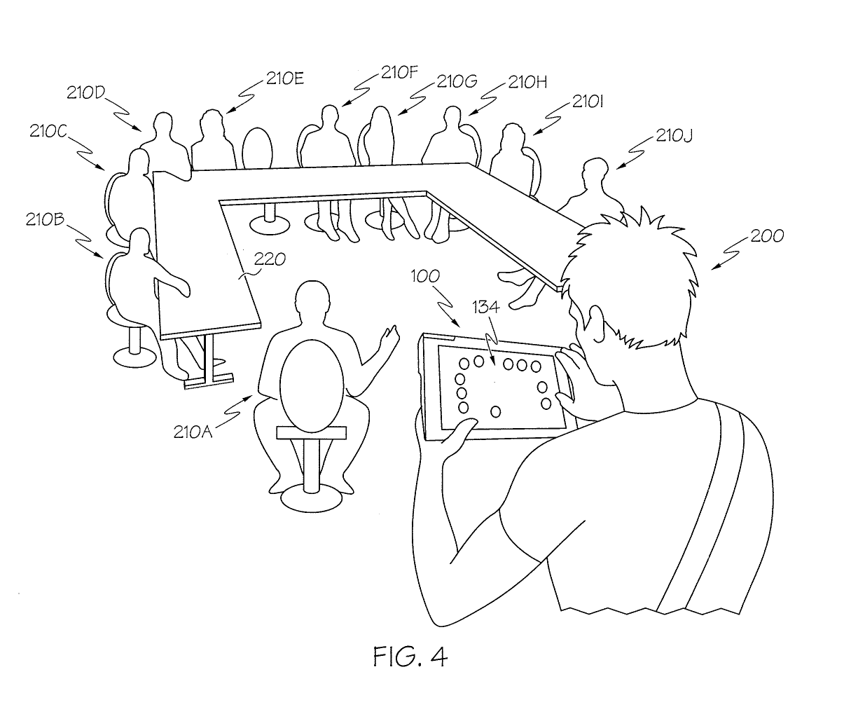

Referring now to FIG. 4, a non-limiting, example use-case of a tactile display device 100 is illustrated. A user 200, such as a blind or visually impaired user, enters a room in which people 210A-210J people are sitting at a conference table 220. The room may be a classroom or a conference room where a meeting is taking place, for example. The user 200 may desire to know where the people are located in the room. Using the input device(s) 138 or the microphone 142, he may select “people” as the class of object he wishes for the tactile display device 100 detects. He may hold up the tactile display device 100 to capture image data. The capturing of image data may occur automatically when the user 200 holds the tactile display device 100 in a substantially vertical orientation, or when he provides an input requesting that the tactile display device 100 capture image data.

The captured image data is then analyzed to detect the presence and location of people within the room. A topographical map is generated from the image data that includes the people within the room. The topographical map is converted into tactile display data that is provided to the tactile display 134, which then displays the tactile message 137 accordingly.

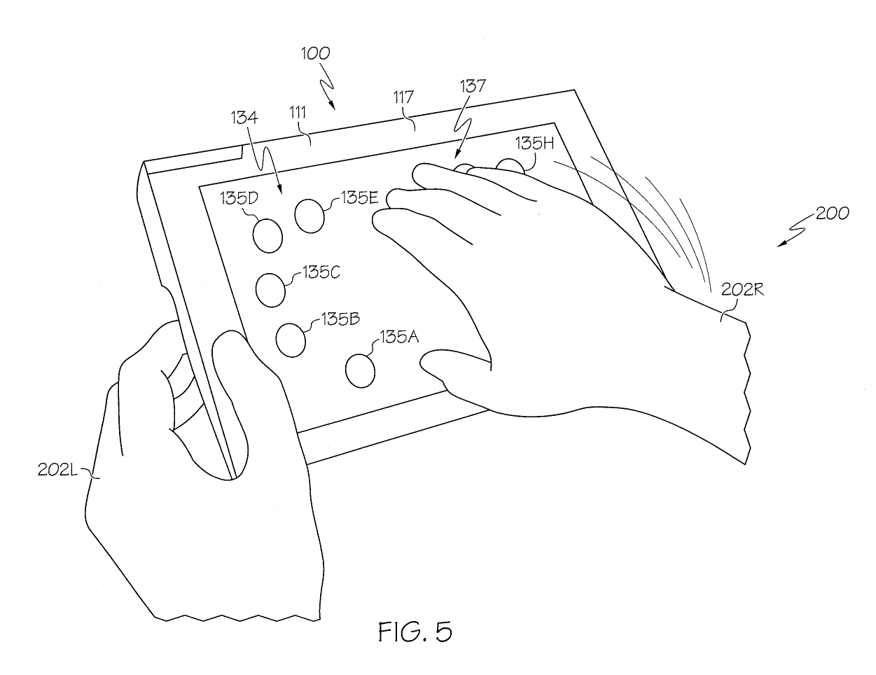

Referring to FIG. 5, the illustrated user 200 is holding the tactile display device 100 with his left hand 202L while reading the tactile message 137 on the tactile display 134 with his right hand 202R. The user may access the rear surface 113 input devices 138 with his left hand 202L while reading the tactile display device 100 with his or her right hand 202R, for example. As shown in FIG. 5, the tactile message 137 includes raised portions 135A-135J (some of which are obscured by the user's right hand 202R) that correspond to the location of the people 210A-210J in the room. If the tactile display device 100 is configured to detect faces of people, one or more of the raised portions 135A-135J may include Braille text indicating the name of one or more of the people 210A-210J in the environment. The speaker 140 may also produce an audio message that describes the layout of the room, or requests input from the user.

It should now be understood that embodiments described herein are directed to tactile message devices capable of providing tactile information about a visually impaired user's environment. Embodiments of the present disclosure capture image data of a user's environment, detect objects from the captured image data, and display a topographical map in accordance with the detected objects in a tactile message provided on a tactile display. In this manner, a blind or visually impaired user may determine the presence and location of desired objects within his or her environment. Embodiments may also provide audio messages regarding the user's embodiments, as well as convert written text to Braille or another tactile writing system.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A tactile display device comprising:
a housing having a first surface;
a tactile display located at the first surface of the housing, the tactile display configured to produce a plurality of raised portions defining a tactile message;
a camera configured to generate image data corresponding to an environment;
a processor disposed within the housing and communicatively coupled to the tactile display and the camera; and
a non-transitory memory device storing machine-readable instructions that, when executed by the processor, cause the processor to:
generate a topographical map of objects within the environment from the image data received from the camera;
generate tactile display data corresponding to the topographical map; and
provide the tactile display data to the tactile display such that the tactile display produces the plurality of raised portions to form the tactile message.

2. The tactile display device as claimed in claim 1, wherein the machine-readable instructions further cause the processor to generate a navigational route within the topographical map such that the tactile display data includes the navigational route and the tactile message displays a tactile representation of the navigational route.

3. The tactile display device as claimed in claim 1, wherein the non-transitory memory stores topographical map information, and the machine-readable instructions further cause the processor to:
access the topographical map information to retrieve topographical information corresponding to a location of a user within the environment; and
generate the tactile display data based in part on the topographical information corresponding to the location of the user within the environment.

4. The tactile display device as claimed in claim 3, wherein the topographical map information comprises information relating to interior spaces of a building.

5. The tactile display device as claimed in claim 4, wherein the topographical map information comprises information regarding a location of one or more doorways.

6. The tactile display device as claimed in claim 3, further comprising a global positioning system sensor, wherein the location of the user within the environment is determined at least in part by the global positioning system sensor.

7. The tactile display device as claimed in claim 1, wherein the tactile display data is such that the tactile message that is displayed by the tactile display includes one or more Braille messages corresponding to a name of one or more persons within the environment.

8. The tactile display device as claimed in claim 7, wherein a position of the one or more Braille messages within the tactile message corresponds with a position of the one or more persons within the environment.

9. The tactile display device as claimed in claim 1, further comprising an input device, wherein a class of the objects within the environment displayed by the tactile message on the tactile display is user-selectable by the input device.

10. The tactile display device as claimed in claim 9, wherein the machine-readable instructions further cause the processor to determine the class of objects within the environment by applying an object recognition algorithm to the image data.

11. The tactile display device as claimed in claim 9, wherein the housing has a second surface that is opposite from the first surface, and the input device is disposed on the second surface.

12. The tactile display device as claimed in claim 9, wherein the input device comprises one or more touch-sensitive regions on the tactile display.

13. The tactile display device as claimed in claim 9, wherein the input device is a microphone.

14. The tactile display device as claimed in claim 1, wherein the camera comprises a first camera and a second camera, and the image data corresponds to a stereoscopic image of the environment formed by a combination of a first image created by the first camera and a second image formed by the second camera.

15. The tactile display device as claimed in claim 14, wherein:
the stereoscopic image provides depth information with respect to the environment; and
the tactile message presents the depth information with respect to the environment.

16. The tactile display device as claimed in claim 1, wherein the machine-readable instructions further cause the processor to extract text from the image data, and the tactile message is configured as a Braille message corresponding to the extracted text.

17. The tactile display device as claimed in claim 1, further comprising an audio output device electrically coupled to the processor, wherein the machine-readable instructions further instruct the processor to:
generate audio message data corresponding to objects within the environment according to the image data received from the camera; and
provide the audio message data to the audio output device such that the audio output device produces sound in accordance with the audio message data.

18. A tactile display device comprising:
a housing having a first surface and a second surface that is opposite from the first surface;
a tactile display located at the first surface of the housing, the tactile display configured to produce a plurality of raised portions defining a tactile message;
a touch-sensitive input region disposed on a surface of the tactile display;
an input device disposed at the second surface of the housing;
a camera configured to generate image data corresponding to an environment;
a processor; and
a non-transitory memory device storing machine-readable instructions that, when executed by the processor, cause the processor to:
receive a user input from the input device or the touch-sensitive input region;
analyze the image data to determine a class of objects within the environment, wherein the user input indicates a desired class of objects for display in the tactile message;
generate a topographical map of objects having the desired class according to the user input;
generate tactile display data corresponding to the topographical map; and
provide the tactile display data to the tactile display such that the tactile display produces the plurality of raised portions to form the tactile message.

19. The tactile display device as claimed in claim 18, further comprising an audio output device electrically coupled to the processor, wherein the machine-readable instructions further instruct the processor to:
generate audio message data corresponding to the desired class of objects within the environment according to the image data received from the camera; and
provide the audio message data to the audio output device such that the audio output device produces sound in accordance with the audio message data.

20. The tactile display device as claimed in claim 18, wherein the machine-readable instructions further cause the processor to generate a navigational route within the topographical map such that the tactile display data includes the navigational route and the tactile message displays a tactile representation of the navigational route.
